(19) United States
(12) Patent Application Publication
(10) Pub. No.: US 2014/0249909 A1
(43) Pub. Date: Sep. 4, 2014

(54) ELECTRONIC RECEIPT SYSTEM, INFORMATION PROCESSING APPARATUS, AND PROGRAM THEREFOR

(71) Applicant: TOSHIBA TEC KABUSHIKI KAISHA, Tokyo (JP)

(72) Inventors: Tsuyoshi GOTANDA, Tokyo (JP); Keiichi HASEGAWA, Tokyo (JP); Satoru ISHIHARA, Osaka (JP); Etsuroh KAWAMURA, Chiba (JP)

(73) Assignee: TOSHIBA TEC KABUSHIKI KAISHA, Tokyo (JP)

(21) Appl. No.: 14/194,535

(22) Filed: Feb. 28, 2014

(30) Foreign Application Priority Data
Mar. 1, 2013 (JP) 2013-041298
Aug. 8, 2013 (JP) 2013-165353

(51) Int. Cl. G06Q 20/04; G06Q 30/02

(52) U.S. Cl. CPC G06Q 20/045; G06Q 30/0226
USPC 705/14.27

(57) ABSTRACT

An electronic receipt system includes an electronic receipt collective management unit which associates a code of a consumer with electronic receipt information including information concerning a payment made by the consumer in different stores, a reception unit which receives an input a search condition pertaining to an electronic receipt, a search unit which searches the electronic receipt collective management unit based on the search condition, and an output unit which outputs a result of search acquired by the search unit.

### CROSS-REFERENCE TO RELATED APPLICATION

This application is based upon and claims the benefit of priority from Japanese Patent Application No. 2013-165353, filed Aug. 8, 2013, and Japanese Patent Application No. 2013-41298, filed Mar. 1, 2013; the entire contents of both applications are incorporated herein by reference.

### FIELD

Embodiments described herein relate generally to an electronic receipt system, an information processing apparatus, and a program therefor.

### BACKGROUND

In an electronic receipt system of the related art, a receipt or an acknowledgment of payment, that is handed over to a consumer who is a shopper at a store when a product payment is performed, is electrically delivered to a mobile terminal of the consumer.

Such a system is beneficial to the consumer because it is possible to electrically and automatically perform bookkeeping on household accounts by using receipts presented or saved as electronic data as described above. In addition, it is possible to reduce the consumption of paper used for the paper receipts, and thus such a system is beneficial to a receipt providing entity such as a store.

In addition, it is known that product sale promotion or advertisement can be performed by electrically adding a discount or rebate coupon, or the like, which is related to a purchased product, to an electronic receipt.

However, the electronic receipt system of the related art is only introduced on a per company basis. Therefore, a consumer who is a user of the electronic receipt system may only enjoy the benefits of the electronic receipt system at stores of a company which has introduced the electronic receipt system. In addition, although it is possible to find a consumer who purchased products at a company, it is not possible to obtain a purchase record of the products of a certain company by other companies. Therefore, a technology is desired which enables consumers to be collectively searched based on purchase records maintained by a plurality of companies. In addition, when the consumer makes a purchase from a store of a company which has not introduced the electronic receipt system, the user may only receive a paper receipt as in the related art, and thus it is desired to promote a wider introduction of the electronic receipt system.

### DESCRIPTION OF THE DRAWINGS

FIG. 1 is a configuration diagram illustrating an overall configuration of an electronic receipt system according to an embodiment.

FIG. 2 is a block diagram illustrating configurations of various parts of a mobile terminal.

FIG. 3 is a block diagram illustrating configurations of various parts of a POS terminal.

FIG. 4 is a block diagram illustrating configurations of various parts of an electronic receipt server.

FIG. 5 is a block diagram illustrating configurations of various parts of an electronic receipt management server.

FIG. 6 is a functional block diagram illustrating an electronic receipt process performed in the POS terminal.

FIG. 7 is a flowchart illustrating the flow of the electronic receipt process.

FIG. 8 is a flowchart illustrating the flow of an information transmission process performed in the electronic receipt server.

FIG. 9 is a functional block diagram pertaining to an electronic receipt management process and a product information transmission process performed in the electronic receipt management server.

FIG. 10 is a flowchart illustrating the flow of the electronic receipt management process and the product information transmission process.

FIG. 11 is a functional block diagram pertaining to an electronic receipt reception process and an electronic receipt reading process performed in the mobile terminal.

FIG. 12 is a flowchart illustrating the flow of the electronic receipt reception process and the electronic receipt reading process.

FIG. 13 is a flowchart illustrating the flow of the electronic receipt reception process and the electronic receipt reading process.

FIG. 14 is a flowchart illustrating the flow of a statistical information generation process performed in the mobile terminal.

FIG. 15 is a diagram schematically illustrating an example of a data configuration of a database which is stored and managed by the electronic receipt management server.

FIG. 16 is a diagram illustrating a search program that implements a search function.

FIG. 17 is a flowchart illustrating the flow of a search process performed by a search unit.

FIG. 18 is a diagram illustrating an example of a recall information input screen.

FIG. 19 is a front view illustrating a display example in the mobile terminal.

FIG. 20 is a front view illustrating a display example in the mobile terminal.

### DETAILED DESCRIPTION

In general, according to one embodiment, an electronic receipt system includes an electronic receipt collective management unit for managing the association of a code of a consumer with electronic receipt information including information concerning payment by the consumer at each store at which the consumer has made a purchase, a reception unit for receiving an input of a search condition pertaining to an electronic receipt, a search system for searching the electronic receipt collective management unit based on the search condition; and an output unit for outputting a result of the search acquired by the search system.

As an application example of an electronic receipt, it is possible to use electronic receipt information which is collected by an electronic receipt center (an electronic receipt management server 9 which will be described later) in order to trace a purchaser of a product. In the electronic receipt center, it is possible to collect product sale data for a plurality of sellers (companies) each operating one or more stores, and the product sale data (product information, sale date and time, and the like) is associated with a seller (company), a sale store, member information, and the like. Therefore, it is possible to specify the purchaser of the product based on the product sale data.

An embodiment will be described with reference to the accompanying drawings.

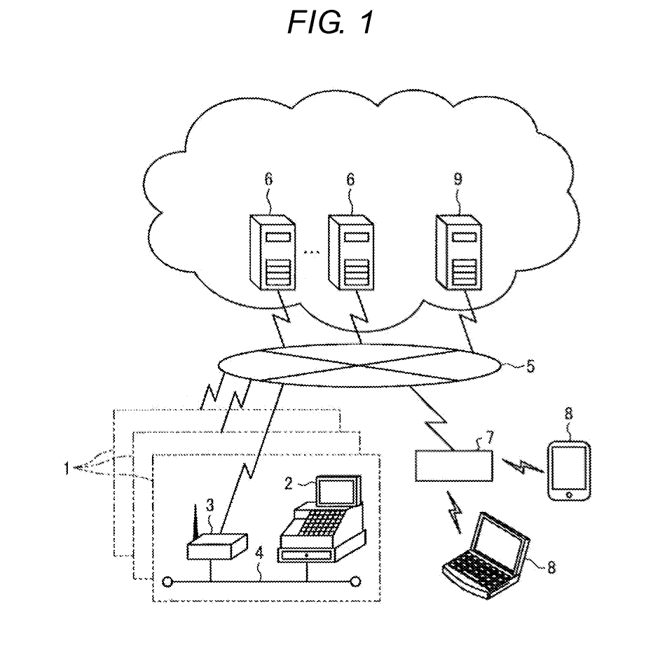

FIG. 1 is a configuration diagram illustrating an overall configuration of an electronic receipt system according to an embodiment. As shown in FIG. 1, a store 1 is provided with a Point of Sales (POS) terminal 2 (although one POS terminal is shown in FIG. 1, a plurality POS terminals may be provided) which is a product sale data processing apparatus that performs a product sale data process, and a router 3. The POS terminal 2 is connected to the router 3 through a Local Area Network (LAN) 4 in the store. The router 3 is a device which causes the LAN 4 in the store to be connected to a network 5 which is the Internet or a Virtual Private Network (VPN). Meanwhile, although not particularly shown in the drawing, a store server which integrally operates or interfaces with the POS terminal 2 may be provided in the store 1.

An electronic receipt server 6 is connected to the network 5. The electronic receipt server 6 is provided in plural, one for each company which operates a store, such as a convenience store, a supermarket, a food store, a drug store, an apparel store, a home electronic appliance store, a department store, a household goods store, and a food and beverage store, or a chain store (hereinafter, referred to as a “store”) and which is a seller of a product or a service. Further, the electronic receipt server 6 functions as a receipt management server for a company, which stores and manages electronic receipt information for each company code indicating the company that operates the store. Alternatively, a head-office server of a POS system, which has functions of sales management, sales analysis, inventory management and the like of each company that operates a store, may be used as electronic receipt server 6 which is dedicated to each separate company.

In addition, a mobile terminal 8 is connected to the network 5 through a base station 7 that performs wireless communication in compliance under a standard such as Wireless Fidelity (Wi-Fi). The mobile terminal 8 is an information processing apparatus that includes, for example, a smart phone, a mobile phone, a Personal Digital Assistant (PDA), a tablet-type computer, or the like which is provided with a Web browser. Meanwhile, an information processing apparatus, such as a personal computer including a notebook computer or the like, may be used instead of the mobile terminal 8.

Further, the electronic receipt management server 9, which functions as a customer receipt management server that collectively stores and manages the electronic receipt information of various companies that operate a store, is connected to the network 5. It is possible for a consumer who is registered as a member of an electronic receipt system employing the receipt management server 9 to receive electronic receipt information from the electronic receipt management server 9 through the network 5 using the mobile terminal 8. The electronic receipt management server 9 is managed by, for example, a trusted third party other than companies for which electronic receipt information is managed using the electronic receipt server 6. Meanwhile, the electronic receipt server 6 may be managed by the trusted third party or the like. In addition, management may be performed by a single server in a manner that the function of the electronic receipt server 6 is given to the electronic receipt management server 9. In addition, a function of collectively managing electronic receipt information for each company, which is indicating a company that operates a store using a plurality of company codes, may be provided such that a service (application) is provided in the form of, for example, Software as a Service (SaaS) which is a type of cloud computing.

Meanwhile, member registration of a consumer to allow the consumer to receive an electronic receipt service is performed, for example, as follows. A consumer transmits an no content e-mail to a member management server from the mobile terminal 8 through the network 5. The member management server transmits a Uniform Resource Locator (URL) indicating a page for member registration to the email address of the received e-mail. The consumer accesses the URL indicating the page for member registration from the mobile terminal 8, displays an input screen, and inputs items which are necessary for the member registration. An input confirmation screen is displayed on the mobile terminal 8 after the consumer completes the input of the necessary items. Further, after the consumer confirms the input, the member registration is performed on a member master list. Thereafter, the member management server transmits a member registration completion mail which includes a member code and a password associated with the new member to the mobile terminal 8. Therefore, the member registration ends. Meanwhile, after the registration is completed, a “top screen display” button is provided in a registration completion screen which is displayed on the mobile terminal 8. When the consumer operates the “top screen display” button, the mobile terminal 8 displays a top screen.

In the electronic receipt system which includes the above configuration, electronic receipt information indicating payment content, which is generated in a manner that a product sale data process is performed by the POS terminal 2 in the store 1, is transmitted to the electronic receipt management server 9 through the network 5 and the electronic receipt server 6, and the electronic receipt information is transmitted to the mobile terminal 8 of a member from the electronic receipt management server 9. The member may display the electronic receipt information on the display unit of the mobile terminal and may check the content thereof. In addition, the electronic receipt management server 9 publishes the electronic receipt information to a URL accessible on the Web (internet). The mobile terminal 8 which is provided with the Web browser enables the electronic receipt information which is published on the Web to be downloaded on the mobile terminal 8 and enables the electronic receipt information to be read using the Web browser by designating the Uniform Resource Locator (URL) thereof. Meanwhile, the electronic receipt information may be read by installing application software to read the electronic receipt information in the mobile terminal 8.

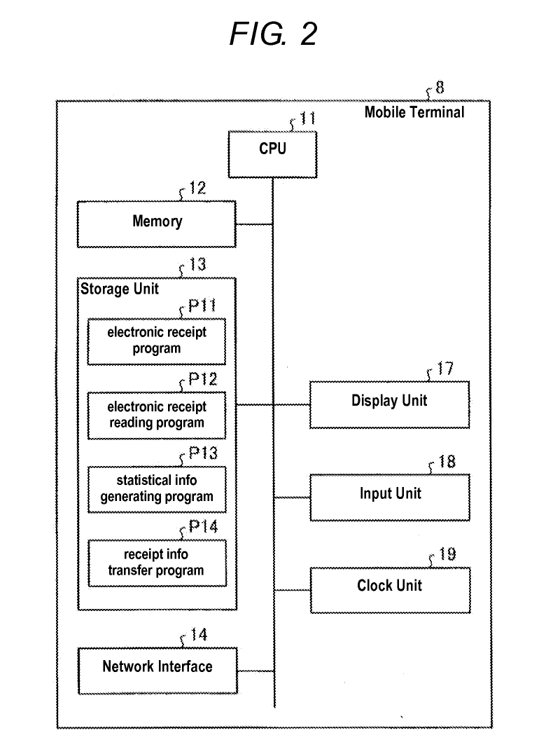

The mobile terminal 8 stores the member code and the password, which are acquired by the consumer as described above, in a storage unit 13 (refer to FIG. 2) or the like. A method of outputting the member code which is stored as described above includes a display using a barcode, a display using a two-dimensional code, and transmission based on information communication using Near Field Communication (NFC) which is a near field-type wireless communication, and the like.

Further, the association between the member code, which is acquired by the consumer in order to receive a electronic receipt service, and an existing company member card, such as a point service (seller loyalty program), which is operated by a company, such as a chain store, may be achieved by the POS terminal 2 in each retail store or the mobile terminal 8 of each individual.

Here, an application example of the association between the member code, which is acquired by the consumer as described above, and the existing company member card will be described.

1. Application Example of POS Terminal 2 in Store

(1) First, a checker (check out clerk) who operates the POS terminal 2 checks whether or not an electronic receipt service was performed when a product is registered (paid) and whether or not a point card is present. When the electronic receipt service is performed, the consumer shows the mobile terminal 8 and the point card.

(2) The checker reads a member code which is stored in the mobile terminal 8 and a company member code in the point card, respectively. Here, the member code which is stored in the mobile terminal 8 is read depending on an I/O which is provided in the POS terminal 2. For example, when a code reader which reads a code symbol is provided in the POS terminal 2, a member code which is maintained in a barcode or a two-dimensional code is read. In addition, when a near field radio device in conformity with NFC or the like is provided in the POS terminal 2, a member code which is maintained in an IC tag or the like is read.

(3) The POS terminal 2 transmits a transaction and the member code and the company member code in the point card which are read in (2) to the electronic receipt management server 9.

(4) The electronic receipt management server 9 receives information transmitted in (3), and performs registration in the electronic receipt management server 9 when electronic receipt information indicating payment, which is generated in a manner that the product sale data process is performed in the POS terminal 2 of the store 1, the member code, and the company member code in the point card are simultaneously transmitted for the first time.

Thereafter, it is possible for the consumer to receive an electronic receipt system and loyalty or reward type points by showing only the mobile terminal 8 or the point card at that retailer or selling store entity.

2. Application Example in Mobile Terminal 8

(1) First, the consumer accesses a specific URL using the mobile terminal 8 belonging to the consumer, or logs into a point card registration menu using an application which is installed in the user's mobile terminal 8. The consumer inputs or selects a company which issued the point card to be registered. Subsequently, the consumer inputs the company member code of the point card to be registered and checks the number thereof, presses a registration button, and transmits registration content to the electronic receipt management server 9. Meanwhile, it is possible to input the company member code through manual input, photographing it using a camera on a user device, magnetic reading of the company code, and the like.

(2) The electronic receipt management server 9 receives the registration content in the mobile terminal 8 in (1), combines the registration content with customer information of each company, and returns a display screen for confirmation of the registration to the mobile terminal 8 of the consumer.

(3) When the consumer checks the display screen for the confirmation returned from the electronic receipt management server 9 and presses an agreement button, the association between the member code of the electronic receipt and the existing company member card is completed.

As described above, when the service of providing electronic receipts or the service of giving loyalty or reward points is managed using a unique member code of an electronic receipt, it is possible to receive the service in the electronic receipt system by providing only a point card in a store of which a consumer has a point card and by providing the mobile terminal 8 in a store of which the consumer does not have a point card. As a result, it is possible for the member code of the electronic receipt system which associates each company member card of each company to be used to bring together the electronic information in a single place, i.e., a hub.

Hereinafter, the configuration of respective units which configure the electronic receipt system according to the embodiment will be described in consideration of their configuration.

First, the configuration of various parts of the mobile terminal 8, which functions in part as an information processing apparatus, will be described with reference to a block diagram in FIG. 2. As shown in FIG. 2, the mobile terminal 8 includes a Central Processing Unit (CPU) 11 functioning as a control unit, a memory 12 which temporarily stores data, a storage unit 13 which may be read from and written to based on a command from the CPU 11 and in which a program, data or the like is stored, a network interface 14 which is connected to various public networks including the network 5, a display unit 17 which may display various information, an input unit 18 which is used to operate the mobile terminal 8, a clock unit 19 which tracks time, and the like. The input unit 18 includes a touch panel which is laminated on the display unit 17 or keys which are provided on a housing.

In the storage unit 13, an electronic receipt program P11 which is used to receive electronic receipt information generated by the electronic receipt management server 9 after a payment is made through a product sale data process, and an electronic receipt reading program P12 which is used to read the received electronic receipt information, are pre-installed, in addition to a Web browser which is used to read various information (content) that are published on the Web.

In addition, in the storage unit 13, a statistical information generation program P13 is pre-installed and which is used to generate statistical information acquired by compiling statistics for the electronic receipt information received from the electronic receipt server 6 of each company, the function of which will be described later based on a company code and a business type code.

Further, in the storage unit 13, a receipt information transfer program P14 is pre-installed and which is used to perform division of the electronic receipt information and to transfer the resulting electronic receipt information to other people or entities.

Meanwhile, the electronic receipt corresponding program P11, the electronic receipt reading program P12, the statistical information generation program P13, and the receipt information transfer program P14 which are performed in the mobile terminal 8 are recorded in a computer readable recording medium, such as a CD-ROM, a flexible disk (FD), a CD-R, and a Digital Versatile Disk (DVD), in the form of installable type or executable type files.

In addition, a configuration may be made such that the electronic receipt corresponding program P11, the electronic receipt reading program P12, the statistical information generation program P13, and the receipt information transfer program P14 which are executed in the mobile terminal 8 are stored on a computer which is connected to a network, such as the Internet, and are provided by being downloaded through the network. In addition, a configuration may be made such that the electronic receipt corresponding program P11, the electronic receipt reading program P12, the statistical information generation program P13, and the receipt information transfer program P14 which are executed in the mobile terminal 8 are provided or distributed through a network such as the Internet.

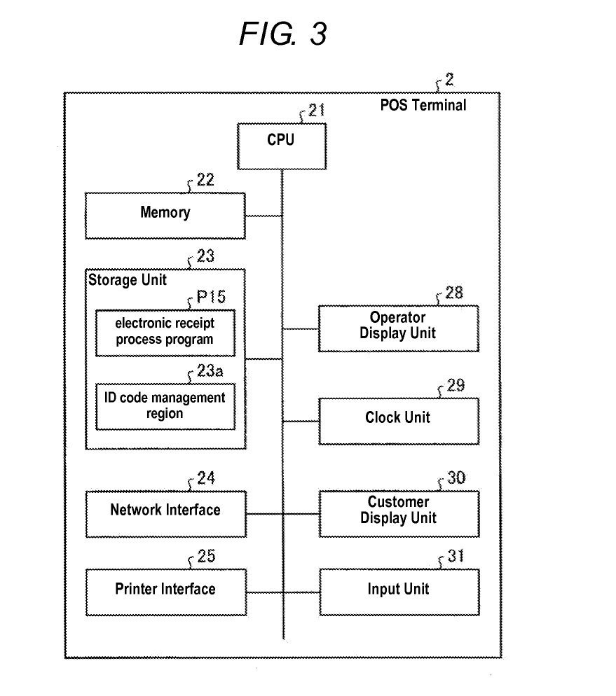

Subsequently, configurations of various parts of the POS terminal 2 which is the product sale data processing apparatus will be described with reference to a block diagram in FIG. 3. As shown in FIG. 3, the POS terminal 2 includes a Central Processing Unit (CPU) 21 functioning as the control unit, a memory 22 which temporarily stores data, a storage unit 23 which may be read and written based on a command from the CPU 21 and in which a program, data, or the like is stored, a network interface 24 which is connected to the LAN 4 in the store, a printer interface 25 to which a printer is connected, an operator display unit 28 which is used to display various information for an operator, a clock unit 29 which is used to clock time, a customer display unit 30 which is used to display various information to a customer, an input unit 31 which is used to operate the POS terminal 2, and the like.

In the storage unit 23, an identification code management region 23a is secured as a region which is used to store a company code (an identification code of a company which operates one or more stores), a business type code, a store code indicating the store 1 in which the POS terminal 2 is installed, and the like in advance in addition to the POS number of the POS terminal 2. Here, the business type code is a code (classification code) which classifies the business type of a store which includes, for example, a convenience store, a supermarket, a department store, a drug store, a restaurant, a food and beverage store, or the like. Meanwhile, it is possible to arbitrarily change such a business type depending on user preference. Meanwhile, the company code (the identification code of a company which operates a store) and the business type code may be registered in the electronic receipt server 6.

In addition, in the storage unit 23, in addition to software to perform various POS tasks including the product sale data process, an electronic receipt process program P15 is pre-installed for processing the electronically processed electronic receipt information instead of a receipt or an acknowledgment of payment which is printed and issued when the product sale data process is performed.

The electronic receipt process program P15 which is executed in the POS terminal 2 is provided thereto by being recorded in a computer readable recording medium, such as a CD-ROM, a Flexible Disk (FD), a CD-R, or a Digital Versatile Disk (DVD), in the form of an installable type or executable type file.

In addition, a configuration may be made such that the electronic receipt process program P15 which is executed in the POS terminal 2 is stored in a computer which is connected to a network, such as the Internet, and is provided by being downloaded through the network. In addition, a configuration may be made such that the electronic receipt process program P15 which is executed in the POS terminal 2 is provided or distributed through the network such as the Internet.

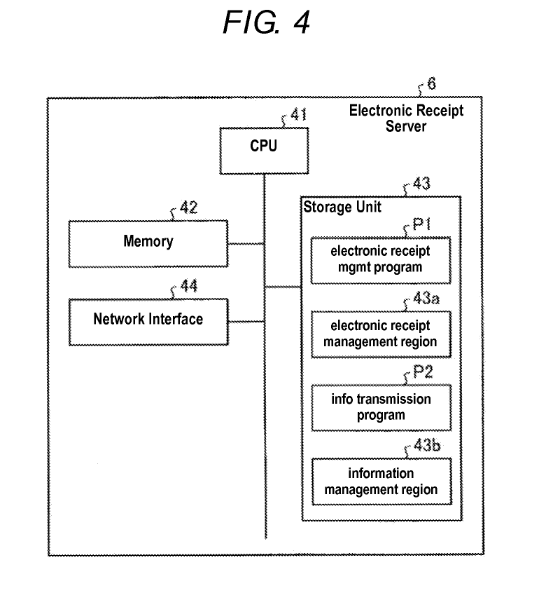

Subsequently, configurations of various parts of the electronic receipt server 6 which functions as a receipt management server for a company will be described with reference to a block diagram in FIG. 4. The electronic receipt server 6 includes a Central Processing Unit (CPU) 41 functioning as the control unit, a memory 42 which temporarily stores data, a storage unit 43 which may be read from and written to based on a command from the CPU 41 and in which a program, data, or the like is stored, a network interface 44 which is connected to the network 5, and the like.

In the storage unit 43, an electronic receipt management region 43a is secured as a region which is used to store electronic receipt information for each company which operates a store. The electronic receipt information includes a company code (an identification code of a company which operates a store), a business type code, a store code, a member code of the consumer (user), the POS number of the POS terminal 2, a receipt number, product sale data, and the like.

In addition, in the storage unit 43, an electronic receipt management program P1 is pre-installed to manage the electronic receipt information, which is received from the POS terminal 2 of each store 1, in the electronic receipt management region 43a.

In addition, in the storage unit 43, an information transmission program P2 is pre-installed to transmit the electronic receipt information, which is managed in the electronic receipt management region 43a, to the electronic receipt management server 9.

Further, in the storage unit 43, an information management region 43b is provided which stores various additional information associated with a desired product, a member, a company, and a store. Here, the additional information is access information, such as a URL which is linked to a homepage that is associated with a campaign of a company, a URL which is linked to a homepage that is associated with a commercial of a company, and a URL which is linked to a coupon of a company.

Meanwhile, the electronic receipt management program. P1 and the information transmission program P2 which are executed in the electronic receipt server 6 are provided by being recorded in a computer readable recording medium, such as a CD-ROM, a Flexible Disk (FD), a CD-R, or a Digital Versatile Disk (DVD), in the form of an installable type or executable type file.

In addition, a configuration may be made such that the electronic receipt management program P1 and the information transmission program P2 which are executed in the electronic receipt server 6 are stored in a computer which is connected to the network, such as the Internet, and are provided by being downloaded through the network. In addition, a configuration may be made such that the electronic receipt management program P1 and the information transmission program P2 which are executed in the electronic receipt server 6 are provided or distributed through the network such as the Internet.

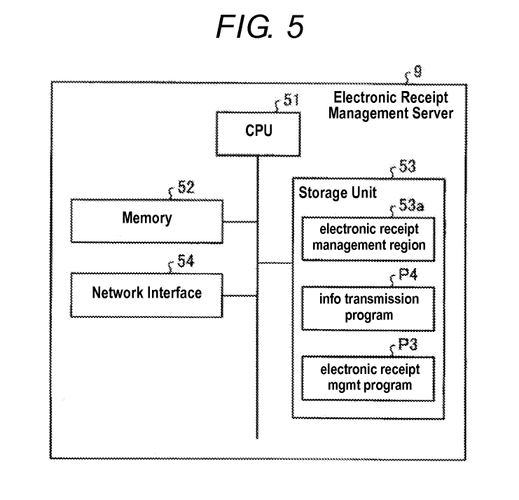

A configuration of various parts of the electronic receipt management server 9 which functions as the receipt management server for a customer will be described with reference to a block diagram in FIG. 5. The electronic receipt management server 9 includes a Central Processing Unit (CPU) functioning as the control unit, a memory 52 which temporarily stores data, a storage unit 53 which may be read and written based on a command from the CPU 51 and in which a program, data, or the like is stored, a network interface 54 which is connected to the network 5, and the like.

In the storage unit 53, an electronic receipt management region 53a is secured as a region which is used to collectively store the electronic receipt information of various companies which operate stores. More specifically, the electronic receipt management region 53a is used to manage the electronic receipt information and the additional information of various companies which operate stores for each member. The electronic receipt information includes a member code, a company code (an identification code of a company which operates a store), a store code, the POS number of the POS terminal 2, a receipt number, product sale data, additional information, and the like.

In addition, in the storage unit 53, an electronic receipt management program P3 is pre-installed to manage the electronic receipt information and the additional information which are received from the electronic receipt server 6 of each company in the electronic receipt management region 53a.

In addition, in the storage unit 53, an information transmission program P4 is pre-installed to transmit the electronic receipt information and the additional information of a desired product to the mobile terminal 8.

Meanwhile, the electronic receipt management program. P3 and the information transmission program P4 which are executed in the electronic receipt management server 9 are provided by being recorded in a computer readable recording medium, such as a CD-ROM, a Flexible Disk (FD), a CD-R, or a Digital Versatile Disk (DVD), in the form of an installable type or executable type file.

In addition, a configuration may be made such that the electronic receipt management program P3 and the information transmission program P4 which are executed in the electronic receipt management server 9 are stored in a computer which is connected to the network, such as the Internet, and are provided by being downloaded through the network. In addition, a configuration may be made such that the electronic receipt management program P3 and the information transmission program P4 which are executed in the electronic receipt management server 9 are provided or distributed through a network such as the Internet.

Subsequently, the operations of respective units which form the system according to the embodiment will be described.

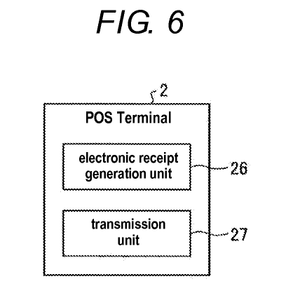

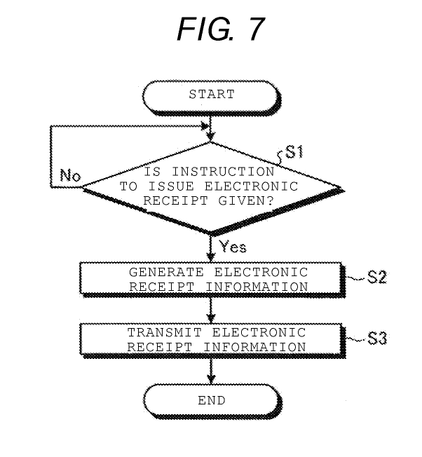

First, an electronic receipt process which is executed in a manner that the CPU 21 of the POS terminal 2 operates in accordance with the electronic receipt process program P15 will be described with reference to a functional block diagram shown in FIG. 6 and a flowchart shown in FIG. 7.

As shown in FIG. 6, the electronic receipt process program P15 which is executed in the POS terminal 2 has a module configuration which includes an electronic receipt generation unit 26 that functions as an electronic receipt generation section and a transmission unit 27 that functions as a transmission section. Within actual hardware, when the CPU 21 reads the electronic receipt process program P15 from the storage unit 23 and executes the electronic receipt process program P15, the respective units are loaded into the memory 22, and the electronic receipt generation unit 26 and the transmission unit 27 are stored in the memory 22.

The electronic receipt generation unit 26 includes a company code indicating a company which operates a store, and generates electronically processed electronic receipt information in association with the member code of the consumer instead of a receipt or an acknowledgment of payment which is printed and issued when the product sale data process is performed. Meanwhile, the electronic receipt information includes product sale data which is configured to include elements, such as product information including a product name, a product code, a price and the like of each product which is a target of sale, and sale date and time indicating date and time at which product sale (payment) occurred. Here, the product name and the product code are product identification information which is used to identify each product.

The transmission unit 27 transmits the electronic receipt information which is generated in the electronic receipt generation unit 26 to the electronic receipt server 6 which performs management in correspondence with a company according to a company code.

As shown in FIG. 7, when input of a closing operation key or the like is operated to start a product transaction closing process, the CPU 21 (the electronic receipt generation unit 26) of the POS terminal 2 checks whether or not a member code is input and an electronic receipt is issued, and determines whether or not an instruction to issue the electronic receipt corresponding to a payment process according to a closing operation is given (step S1).

In order for a member to cause the instruction to issue the electronic receipt to occur, for example, a method as follows may be considered.

1. A clerk operates an “electronic receipt issue” button which is provided in the input unit 31 (for example, a keyboard) of the POS terminal 2.

2. A consumer who is a member displays a barcode which includes a code that is shown on the display unit 17 of the mobile terminal 8, and the clerk reads the barcode using the input unit 31 (for example, a barcode scanner) of the POS terminal 2.

3. The consumer who is a member presses the “electronic receipt issue” button which is displayed on the customer display unit 30.

4. The consumer who is a member displays the barcode which includes the code that is on the display unit 17 of the mobile terminal 8, and the consumer who is a member personally reads the barcode using the input unit 31 of the POS terminal 2 (for example, a barcode scanner (it is preferable to use a scanner which is different from a scanner used to register a product)).

5. The consumer who is a member shows a company member card to receive a point service, reads a company member code of the company member card using the input unit 31 (for example, a barcode scanner, a magnetic card reader, NFC, or the like) of the POS terminal 2, and determines that an instruction to issue an electronic receipt is given when the read company member code is associated with the member code of the electronic receipt.

The CPU 21 of the POS terminal 2 (the electronic receipt generation unit 26) waits until the instruction to issue the electronic receipt is given (No in step S1). When the CPU 21 (electronic receipt generation unit 26) of the POS terminal 2 determines that the instruction to issue the electronic receipt is given (Yes in step S1), the CPU 21 of the POS terminal 2 transmits product transaction data to a head-office server, extracts the company code (an identification code of a company which operates a store), the business type code, the store code, the member code of the consumer, the POS number of the POS terminal 2, the receipt number, product sale data, and the like in addition to the product transaction data from the identification code management region 23a or the like which is provided in the storage unit 23 based on product information and payment information, which are registered when payment is made through the product sale data process, and generates electronic receipt information (step S2).

Subsequently, the CPU 21 (transmission unit 27) of the POS terminal 2 accesses the LAN 4 in the store or the network 5 through the network interface 24, transmits the generated electronic receipt information to the electronic receipt server 6 (step S3), and ends the process. Meanwhile, when it is determined that the instruction to issue the electronic receipt is not given, a paper receipt is printed and issued, the product transaction data is transmitted to the head-office server, and the process ends.

If the CPU 21 of the POS terminal 2 transmits the product transaction data (transaction data) to the head-office server, and an off-line state is detected, trouble is avoided by performing the following actions.

1. Automatic execution of retry transmission.

2. Where the retry transmission does not cause connection to the head office server, the product transaction data (transaction data) is stored until an online state is restored, and is transmitted to the head-office server after the online state (connection to the head office server) is restored. In this case, the CPU 21 of the POS terminal 2 displays “product transaction data (transaction data) will be transmitted later.” or the like on the operator display unit 28.

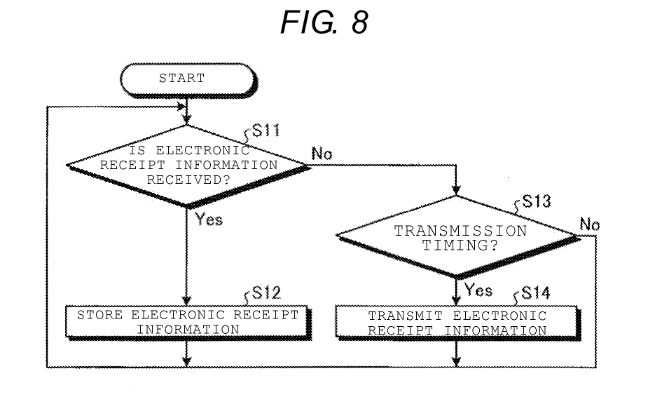

Subsequently, the flow of an electronic receipt management process which is performed in a manner such that the CPU 41 of the electronic receipt server 6 operates according to the electronic receipt management program P1 and the information transmission process which is performed in a manner such that the CPU 41 of the electronic receipt server 6 operates according to the information transmission program P2 will be described with reference to a flowchart shown in FIG. 8.

When the CPU 41 of the electronic receipt server 6 receives the electronic receipt information or the like which is transmitted from the POS terminal 2 through the network interface 44 (Yes in step S11), the CPU 41 of the electronic receipt server 6 stores the electronic receipt information in the electronic receipt management region 43a of the storage unit 43 as electronic receipt information sorted for each company (step S12). That is, the CPU 41 of the electronic receipt server 6 functions as an electronic receipt management section for managing the electronic receipt information in the storage unit 43 sorted by company according to the company code of each company.

In addition, in a case transmission timing is preset to a predetermined time after the CPU 41 of the electronic receipt server 6 stores the received electronic receipt information or the like (No in step S11 and Yes in step S13), the CPU 41 of the electronic receipt server 6 transmits the electronic receipt information which is managed in the electronic receipt management region 43a and the additional information which is managed in the information management region 43b to the electronic receipt management server 9 (step S14), and the process returns to step S11.

Although the CPU 21 (electronic receipt generation unit 26) of the POS terminal 2 generates the electronic receipt information and transmits the electronic receipt information to the electronic receipt server 6, the exemplary embodiment is not limited thereto. For example, the CPU 21 of the POS terminal 2 may transmit the store code, the member code of the consumer, the POS number of the POS terminal 2, the receipt number, the product sale data, and the like to the electronic receipt server 6 based on the product information and the payment information which are registered when the payment is made, by using the product sale data process, and the CPU 41 of the electronic receipt server 6 may generate the electronic receipt information by adding the company code, the business type code, and the like.

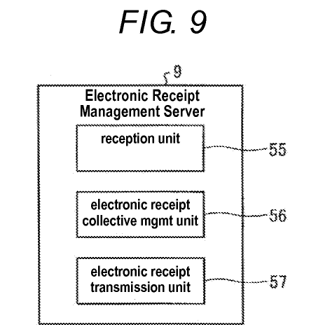

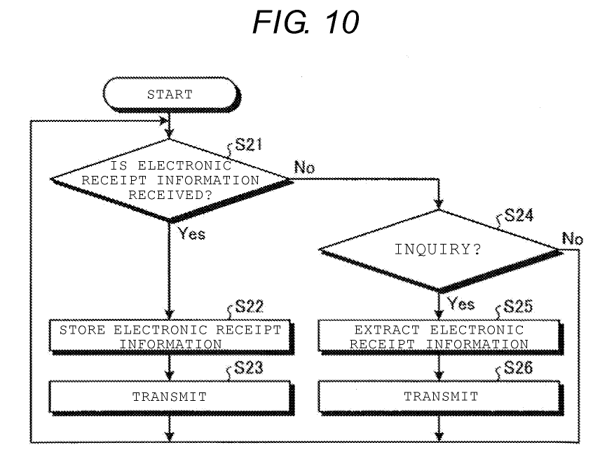

The flow of the electronic receipt management process, which is performed in a manner such that the CPU 51 of the electronic receipt management server 9 operates according to the electronic receipt management program P3, and a product information transmission process, which is performed in a manner such that the CPU 51 of the electronic receipt management server 9 operates according to the information transmission program P4, will be described with reference to a block diagram shown in FIG. 9 an a flowchart shown in FIG. 10.

As shown in FIG. 9, the electronic receipt management program P3 and the information transmission program P4 which are executed in the electronic receipt management server 9 which includes a reception unit 55 which functions as a reception section, an electronic receipt collective management unit 56 which functions as an electronic receipt collective management section, and an electronic receipt transmission unit 57 which functions as an electronic receipt transmission section. When the CPU 51 reads the electronic receipt management program P3 and the information transmission program P4 from the storage unit 53 and executes the electronic receipt management program P3 and the information transmission program P4, the respective information is loaded into the memory 52, and the reception unit 55, the electronic receipt collective management unit 56, and the electronic receipt transmission unit 57 are stored in the memory 52.

The reception unit 55 receives the electronically processed electronic receipt information based on the identities of the company, which includes the company code indicating a company which operates a store, instead of a receipt or an acknowledgment of payment which is printed out and issued when the product sale data process is performed.

The electronic receipt collective management unit 56 stores the electronic receipt information which is received by the reception unit 55 in the electronic receipt management region 53a of the storage unit 53 by company, and performs collective management thereon.

The electronic receipt transmission unit 57 acquires the electronic receipt information which includes at least one company code associated with the member code from the electronic receipt management region 53a, and transmits the electronic receipt information to the mobile terminal 8 which is associated with a predetermined member code of the consumer.

As shown in FIG. 10, the CPU 51 (reception unit 55) of the electronic receipt management server 9 determines whether or not the electronic receipt information and the additional information, which are transmitted from the electronic receipt server 6 of each company, are received through the network interface 54 (step S21).

When the electronic receipt information and the additional information are received (Yes in step S21), the CPU 51 (electronic receipt collective management unit 56) of the electronic receipt management server 9 collectively stores the electronic receipt information and the additional information of the various companies in the electronic receipt management region 53a of the storage unit 53 (step S22).

In addition, after the electronic receipt information and the additional information are collectively stored in the electronic receipt management region 53a, the CPU 51 (electronic receipt transmission unit 57) of the electronic receipt management server 9 transmits the electronic receipt information and the additional information to the mobile terminal 8 (step S23), and the process returns to step S21. Meanwhile, when the transmission of the electronic receipt information is completed, it is possible to manage or monitor the result of transmission of the electronic receipt information by storing a flag indicating the completion of transmission of the electronic receipt information in an electronic receipt management region 58a.

In addition, when the mobile terminal 8 inquires of the electronic receipt information (No in step S21 and Yes in step S24), the CPU 51 (electronic receipt transmission unit 57) of the electronic receipt management server 9 extracts the electronic receipt information and the additional information which are managed in the electronic receipt management region 53a according to the content of the inquiry of the electronic receipt information (step S25), transmits the electronic receipt information and the additional information to the mobile terminal 8 which inquires of the electronic receipt information (step S26), and the process returns to step S21.

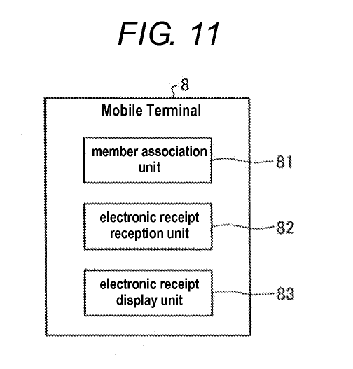

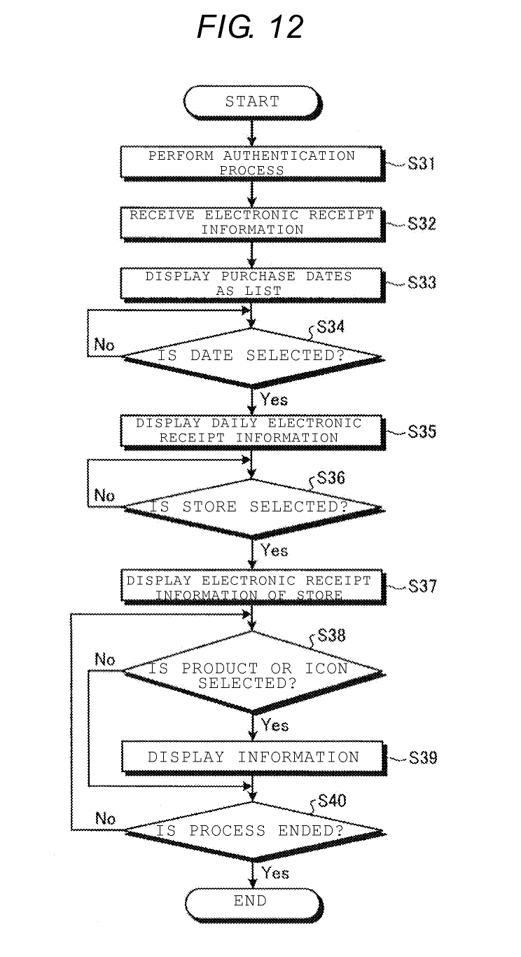

The flow of an electronic receipt reception process which is performed in a manner such that the CPU 11 of the mobile terminal 8 operates according to the electronic receipt corresponding program P11 and an electronic receipt reading process which is performed in a manner such that the CPU 11 of the mobile terminal 8 operates according to the electronic receipt reading program P12 will be described with reference to a functional block diagram shown in FIG. 11 and a flowchart shown in FIG. 12.

As shown in FIG. 11, the electronic receipt corresponding program P11 and the electronic receipt reading program P12 which are executed in the mobile terminal 8 each have a module configuration which includes a member association unit 81 which functions as a member association section, an electronic receipt reception unit 82 which functions as an electronic receipt reception section, and an electronic receipt display unit 83 which functions as an electronic receipt display section. The CPU 11 reads (retrieves) the electronic receipt corresponding program P11 and the electronic receipt reading program P12 from the storage unit 13 and executes the electronic receipt corresponding program P11 and the electronic receipt reading program P12. As a result, each of the units are loaded on the memory 12 and thus the member association unit 81, the electronic receipt reception unit 82, and the electronic receipt display unit 83 are stored on the memory 12.

The member association unit 81 associates a prescribed member code of the consumer.

The electronic receipt reception unit 82 receives the electronic receipt information, which is associated with the member code and which includes at least one company code, from the electronic receipt management server 9 which collectively manages the electronic receipt information.

The electronic receipt display unit 83 aligns the electronic receipt information received by the electronic receipt reception unit 82 in correspondence with a company code, and displays the electronic receipt information on the display unit 17.

As shown in FIG. 12, first, the CPU 11 (member association unit 81) of the mobile terminal 8 accesses the electronic receipt management server 9 and performs an authentication process by inputting the member code and the password (step S31). Therefore, the mobile terminal 8 is associated with the prescribed member code of the consumer.

After the authentication is performed, the CPU 11 of the mobile terminal 8 (electronic receipt reception unit 82) receives the electronic receipt information, which corresponds to the input member code and which is managed in the electronic receipt management region 53a, and the additional information (step S32). Meanwhile, the electronic receipt information and the additional information may be received through an electronic mail.

Subsequently, the CPU 11 of the mobile terminal 8 (electronic receipt display unit 83) displays purchase dates included in the electronic receipt information in a list on the display unit 17 (step S33). The mobile terminal 8 encourages a user who is a consumer to select information by displaying the purchase dates in a list on the display unit 17.

When the CPU 11 (electronic receipt display unit 83) of the mobile terminal 8 determines that the user selects a desired store (Yes in step S36), the CPU 11 displays electronic receipt information corresponding to the selected store on the display unit 17 (step S37).

Here, when the user selects an appropriate product or an icon which is associated with the product (Yes in step S38), the CPU 11 (electronic receipt display unit 83) of the mobile terminal 8 accesses the network 5 through the network interface 14, acquires various information over the network 5 based on access information which is associated with the selected product or the icon, and displays the acquired information on the display unit 17 (step S39).

The CPU 11 of the mobile terminal 8 ends the process when the input unit 18 declares end of the electronic receipt reading process (Yes in step S40).

When the input unit 18 does not declare the end of the electronic receipt reading process (No in step S40), the CPU 11 of the mobile terminal 8 returns to step S38, and waits for the product or the icon which is associated with the product to be selected.

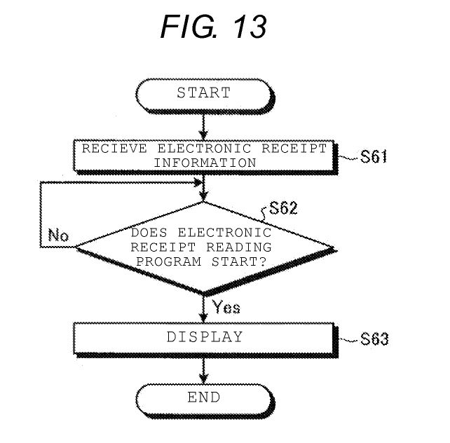

In addition, as described in step S24 in FIG. 10, a case in which the mobile terminal 8 receives the electronic receipt information and the additional information from the electronic receipt management server 9 while the mobile terminal 8 does not access the electronic receipt management server 9 will be described with reference to a flowchart in FIG. 13.

The CPU 11 (electronic receipt reception unit 82) of the mobile terminal 8 receives the electronic receipt information and the additional information from the electronic receipt management server 9 (step S61).

Thereafter, when the electronic receipt reading program P12 starts (Yes in step S62), the CPU 11 (electronic receipt display unit 83) of the mobile terminal 8 associates and displays the received electronic receipt information and the additional information with the company code (step S63).

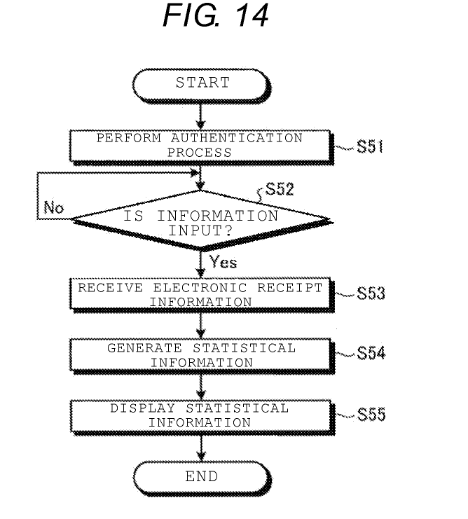

A flow of statistical information generation process which is executed in a manner that the CPU 11 of the mobile terminal 8 operates according to the statistical information generation program P13 will be described with reference to a flowchart shown in FIG. 14.

The CPU 11 of the mobile terminal 8 accesses the electronic receipt management server 9 and performs the authentication process by inputting a member code and a password (step S51).

After the authentication is performed, when the CPU 11 of the mobile terminal 8 determines that information is input which is necessary to generate statistical information such as a period to generate the statistical information, and a type of the statistical information (Yes in step S52), the CPU 11 receives the electronic receipt information which is managed in the electronic receipt management region 53a in correspondence with the input member code and the information which is necessary to generate the statistical information (step S53).

Subsequently, the CPU 11 of the mobile terminal 8 generates statistical information which is acquired based on the information (for example, the company code or the business type code) which is necessary to generate the statistical information from the acquired electronic receipt information (step S54), and displays the generated statistical information on the display unit 17 (step S55).

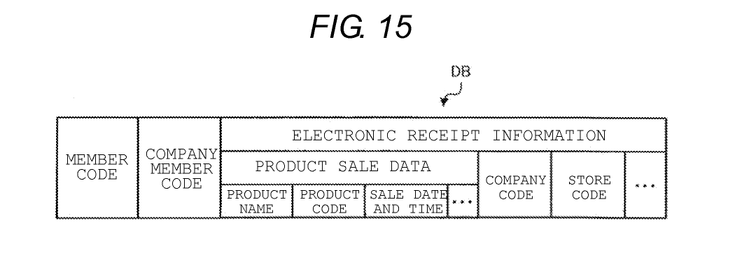

However, according to the electronic receipt system having the above-described configuration, the electronic receipt which is generated by the POS terminal 2 or the electronic receipt server 6 is stored and managed in the database (not shown) or the like of the electronic receipt management server 9 with a data configuration shown in FIG. 15. Here, FIG. 15 is a diagram schematically illustrating an example of a data configuration of a database which is stored and managed by the electronic receipt management server 9.

As shown in FIG. 15, a database DB of the electronic receipt management server 9 stores electronic receipt information which is generated in a store of each company while being associated with the member code of the consumer and the company member code of each company. Here, the electronic receipt information includes elements, such as a company code, and a store code in addition to product sale data (product information (a product name, a product code, sale date and time, and the like)) indicating the payment information. Meanwhile, the elements, such as the member code, and the company member code may be included in the electronic receipt information.

As being apparent from the data configuration in FIG. 15, when a condition in which narrow elements which configure the electronic receipt information (product sale data) is used as a search condition, it is possible to specify electronic receipt information corresponding to the search condition and a user (member code) pertaining to the electronic receipt information as the results of search. For example, when product information (one or more product codes and the like) and payment date and time are designated as the search conditions, it is possible to specify a user (consumer) who purchases a product corresponding to the product information.

Here, when the electronic receipt management server 9 includes a search function capable of searching the database DB, it is possible to effectively utilize information which is registered on the database DB. Therefore, for example, when both the product information and the payment date and time or one of the product information and the payment date and time is set as the search condition, it is possible to specify a purchaser from the database DB using the search function.

Meanwhile, the target of a search is not limited to the identification of a purchaser. When other search conditions are input, it is possible to acquire various types of corresponding information as results of the search. For example, when a specific member code is used as a search condition, it is possible to acquire the purchase record of the consumer having that member code or a tendency for products to be purchased by that member code, as the result of the search. In addition, when the electronic receipt management server 9 includes the search function enabled therein and the electronic receipt management server 9 receives the input of a search request from another device, the results of search may be returned to the device. In addition, the search function is not only included in the electronic receipt management server 9 but also may be included in other apparatuses (for example, the electronic receipt server 6 and the mobile terminal 8).

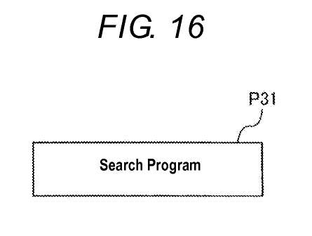

In addition, for example, when a search program P31 shown in FIG. 16 is installed in the storage unit of each apparatus, it is possible to achieve the search function as a search unit (not shown) by cooperating with the CPU of the apparatus.

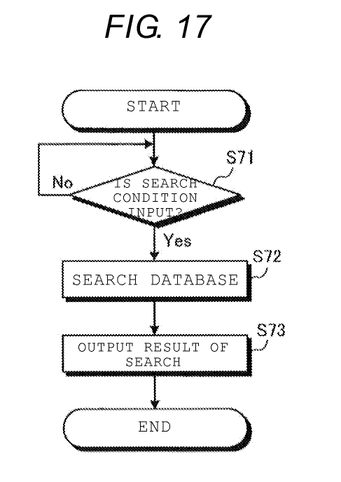

FIG. 17 is a flowchart illustrating the flow of a search process performed by the search unit (search function). First, the search unit waits until a search condition is input (No in step S71).

When input of a search condition is received in step S71 (Yes in step S71), the search unit searches the database DB of the electronic receipt management server 9 based on the search condition (step S72), and outputs a result of search (step S73). Here, a method of outputting a result of search is not particularly specified, the result of search may be output to, for example, a display unit or a printer which is included in each apparatus or may be transmitted to an external apparatus.

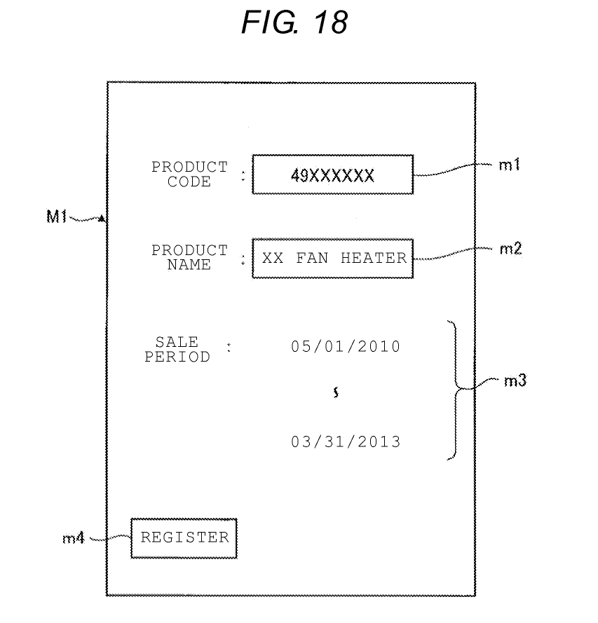

As an embodiment of the search function, a form that a user who purchases a product to be recalled may be informed that the product will be recalled is included may be provided. Hereinafter, the form will be described with reference to FIGS. 18 to 20.

First, a company which manufactures and sells a product to be recalled registers recall information used to specify the product in the electronic receipt management server 9 through a PC or the like (not shown) connected to the network 5. At this time, the electronic receipt management server 9 may provide a recall information input screen to support input of recall information as shown in a display example M1 in FIG. 18.

Here, FIG. 18 is a diagram illustrating an example of the recall information input screen. As shown in the drawing, the recall information input screen includes an area m1 to input a product code of the product to be recalled, an area m2 to input a name of the product, and an area m3 to designate a sale period. In addition, the recall information input screen includes a button m4 to instruct to register recall information. Further, when the button m4 is operated, information which is input in the areas m1 to m3 is registered (transmitted) to the electronic receipt management server 9 as recall information which specifies the product to be recalled.

The CPU 51 (search unit) of the electronic receipt management server 9 receives various items of information which are included in the registered recall information as search conditions, and searches the database DB for the electronic receipt information corresponding to the search conditions. More specifically, the CPU 51 (search unit) of the electronic receipt management server 9 searches (extracts) the database DB for the electronic receipt information which includes the name of the product and the product code corresponding to the search conditions. In addition, the CPU 51 (search unit) of the electronic receipt management server 9 searches the database DB for electronic receipt information in which the sale date and time of the product sale data is included in the sale period corresponding to the search conditions among the extracted electronic receipt information, and outputs a member code corresponding to the product under recall which is associated with the electronic receipt information as a result of search.

Further, the CPU 51 (search unit) of the electronic receipt management server 9 outputs (transmits) a notification of the product being recalled to the mobile terminal 8 corresponding to the member code of the result of search as notification information.

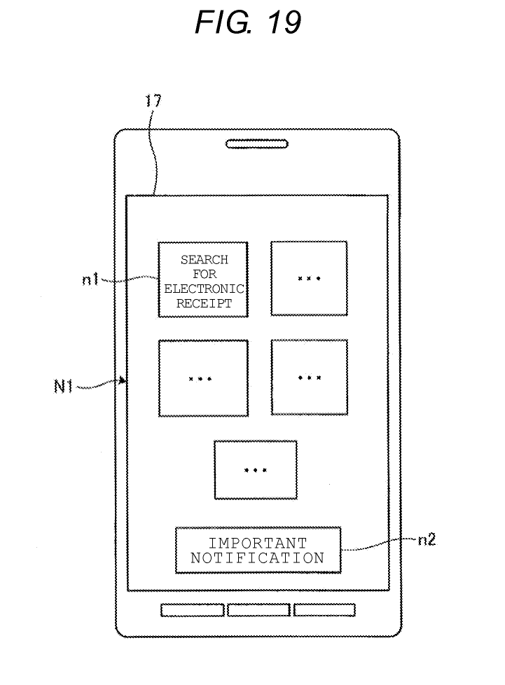

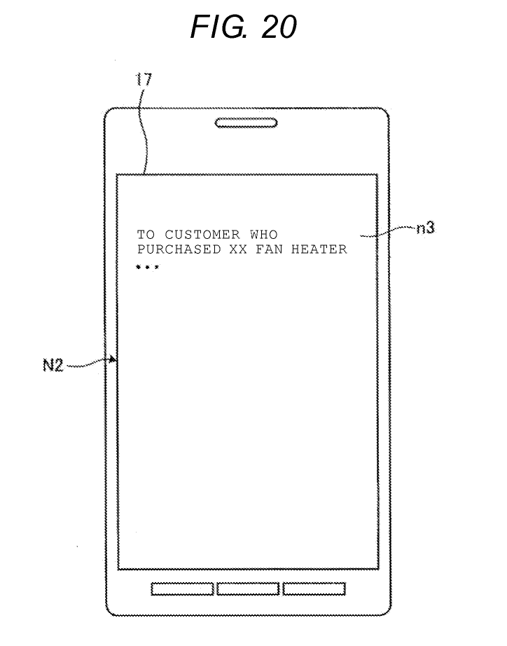

At this time, the mobile terminal 8 may display or otherwise enable showing of the recall notification information to the user of the mobile terminal 8 by, for example, providing a user interface as shown in FIGS. 19 and 20.

FIGS. 19 and 20 are front views illustrating display examples in the display unit 17 of the mobile terminal 8.

To display information, first, the CPU 11 of the mobile terminal 8 displays a button n1 to request a search for an electronic receipt, and a button n2 to display a notification from a company or the like on the display unit 17, as in a display example N1 shown in FIG. 19. When the CPU 11 of the mobile terminal 8 detects selection of the button n2, the CPU 11 displays a notification n3 (notification information), which is transmitted from the electronic receipt management server 9 to the mobile terminal 8, on the display unit 17, as in a display example N2 as shown in FIG. 20.

The method of receiving recall notification information may be different. For example, the CPU 11 of the mobile terminal 8 may transmit a request including the member code to the electronic receipt management server 9 according to the operation of the button n2, and may receive a response from the electronic receipt management server 9. In addition, the CPU 11 of the mobile terminal 8 may display the recall notification information, which is received from the electronic receipt management server 9 in advance, according to the selection of the button n2.

As described above, according to the embodiment, it is possible to automatically and effectively search for a user who purchased a product being recalled and provide notification of the recall to the user. Therefore, it is possible to effectively find the number of products to be recalled which are actually sold, and to recover the products and the like. Meanwhile, the submission of a search condition in the electronic receipt management server 9 is not limited to those pertaining to the recall, and may be extended to other uses. For example, in an attempt to find a criminal and the like, search conditions which narrows specific products or users who purchase the products may be registered in the electronic receipt management server 9 by a police officer and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic receipt system comprising:
an electronic receipt collective management unit configured to manage the association of a code of a consumer with electronic receipt information including information concerning payment by the consumer at each store at which the consumer has made a purchase;
a reception unit configured to receive an input of a search condition pertaining to an electronic receipt;
a search system configured to search the electronic receipt collective management unit based on the search condition; and
an output unit configured to generate a readable result of the search.

2. The electronic receipt system of claim 1, wherein the electronic receipt collective management unit includes a memory unit.

3. The electronic receipt system of claim 2, wherein the memory unit is configured to store associated data concerning purchases by the consumer.

4. The electronic receipt system of claim 3 wherein the associated data associates at least a number code of a consumer, an item or service purchased by the consumer associated with the number code, and the store at which the item or service was purchased by the consumer.

5. The electronic receipt system of claim 4, wherein the system is configured to interact with a consumer terminal having a processor.

6. The electronic receipt system of claim 5, wherein the processor of the consumer terminal is configured to execute an electronic receipt corresponding program an, the electronic receipt reading program, a statistical information generation program, and a receipt information transfer program.

7. The electronic receipt system of claim 1, wherein the electronic receipt collective management unit is configured to associate merchant loyalty program identification with a number code of a consumer.

8. An information processing apparatus comprising:
an electronic receipt collective management unit configured to manage the association of a code of a consumer with electronic receipt information including information concerning payment by the consumer at each store at which the consumer has made a purchase;
a reception unit configured to receive an input of a search condition;
a processor configured to execute a search program that includes instructions to search the electronic receipt collective management system and associate a code of a consumer with electronic receipt information including information concerning payment made by the consumer in each store, based on the search condition which is received by the reception unit; and
an output unit configured to output search results of the search program executed by the processor.

9. The information processing apparatus of claim 8, wherein the search results are classified by the company owning the store.

10. The information processing apparatus of claim 8, wherein the processor is further configured to execute an association program which associates the code with the electronic receipt information.

11. The information processing apparatus, wherein the information associated by the association program is searchable by different types of associated data.

12. The information processing apparatus of claim 11, wherein the searchable associated data includes the store where the consumer made a purchase.

13. The information processing apparatus of claim 12, wherein the output unit is further configured to output information concerning products purchased by a consumer at a specific store.

14. The information processing apparatus of claim 8, wherein
the reception unit is further configured to receive a search for searching the information concerning payment included in the electronic receipt as the search condition, and
the search program is executed to search the electronic receipt collective management unit for electronic receipt information which includes the product sale data corresponding to the search condition.

15. The information processing apparatus of claim 14, wherein
the product sale data includes product identification information,
the reception unit is further configured to receive product identification information of a specific product as a search condition, and
the search program is executed to search the electronic receipt collective management unit for an electronic receipt which includes the product identification information corresponding to the search condition.

16. The information processing apparatus of claim 14, wherein
the product sale data includes sale date and time of a product,
the reception means is further configured to receive a specific sale period as the search condition, and
the search program is executed to search the electronic receipt collective management unit for the electronic receipt in which the sale date and time of the product sale data is included in the sale period corresponding to the search condition.

17. A method of processing electronic sales information, comprising:
receiving an input of a search condition of the electronic sales information;
searching electronic receipt information stores in a collective management device which associates a code of a consumer with electronic receipt information including information concerning payment made by the consumer in one or more stores, based on the received search condition; and
outputting a result of the search.

18. The method of claim 17, wherein the collective management device stores information by:
identifying a code;
identifying an electronic receipt related to the code; and
associating the code and the electronic receipt in a memory unit.

19. The method of claim 18, wherein the collective management device stores information by further identifying at least one of a product type, a payment type, a sales date, and a cost and associating this information with the code and the electronic receipt in the memory unit.

20. The method of claim 17, wherein the collective management device maintains a correspondence between the code and a merchant loyalty card of at least one store.
